(19) United States
(12) Patent Application Publication
(10) Pub. No.: US 2008/0035768 A1
(43) Pub. Date: Feb. 14, 2008

(54) Domestic Appliance for Food Preparation Comprising a Pedestal with Several Housing Positions

(76) Inventors: Franck Ravard, Reze (FR); Stephane Grassin, Fresnay S/Sarthe (FR)

Correspondence Address: BROWDY AND NEIMARK, P.L.L.C.;624 NINTH STREET, NW, SUITE 300, WASHINGTON, DC, 20001-5303, US

(21) Appl. No.: 10/590,416

(22) PCT Filed: Feb. 8, 2005
(86) PCT No.: PCT/FR05/00276

§ 371 Date: Jun. 20, 2007

(30) Foreign Application Priority Data
Feb. 23, 2004 (FR) 0401784

(51) Int. Cl. A47J 43/07

(52) U.S. Cl. 241/37.5

(57) ABSTRACT

The invention relates to a domestic appliance for food preparation, comprising a motor housing, a working container (2), a cover with a detection body, provided to cooperate with a transmission element (22), arranged in the working container (2), when the cover is locked on the working container (2), the transmission element (22) cooperating with a control element (16), arranged in the motor housing to permit the operation of the appliance when the cover closes the working container (2), arranged on the motor housing. According to the invention, the working container (2) may be placed on the motor housing in several angular positions and the control element (16) is mounted such as to be able to rotate against a return means and comprises several detection cams (40), provided to cooperate with the transmission element (22).

The present invention relates to the technical field of electrical household food preparation appliances having a work container disposed on a motor housing forming a base and closed by a lid.

The present invention more particularly relates to appliances of the above mentioned type comprising a safety device prohibiting operation of the motor, of the appliance when the work container is in place on the motor housing and that the lid is not locked on the work container.

In known appliances of this kind, the safety device generally has a safety rod arranged in the wall of the work container. This safety rod cooperates with a switch arranged in the motor housing.

However, the work container must be placed on the motor housing in a given position so that the safety device can actuate the switch. Such an arrangement can prove a nuisance for certain users, in particular for left-handed users.

The object of the present invention is to improve the ergonomics of appliances of the above mentioned type, while preserving a safety device prohibiting the operation of the motor of the appliance when the work container is in place on the motor housing and the lid is not locked on the work container.

This object is achieved with an electrical household food preparation appliance, comprising a motor housing, a work container provided to be placed on the motor housing, a lid provided to close the work container, the lid having a detection body provided to cooperate with a transmission element arranged in the work container when the lid is locked on the work container, the transmission element cooperating with a control element arranged in the motor housing to allow operation of the appliance when the lid closes the work container disposed on the motor housing, owing to the fact that the work container can be placed on the motor housing in several angular positions and in that the control element is mounted to be movable in rotation against a restoring means and has several detection cams arranged to cooperate with the transmission element. Thus the work container can be disposed on the motor housing in various orientations, while preserving the possibility of using a safety device detecting the presence of the lid to allow the operation of the appliance. The control element can be mounted in the motor housing around the motor axis.

Advantageously then the control element forms a crown. This provision makes it possible to arrange the control element around the motor system, which contributes to limiting the size of the safety device.

Advantageously the control element is mounted suspended from a body of the motor housing forming a receiving pedestal for the work container. The body thus forms an upper half-shell of the motor housing, making construction particularly simple.

According to an advantageous embodiment, the control element has side protuberances engaging in side openings of the motor housing. The side protuberances thus make it possible to support the control element. Alternatively, the control element could be supported on ribs of the motor housing.

Advantageously, according to the preceding arrangement, at least one of the side protuberances carries one of the detection cams designed to cooperate with the transmission element. Alternatively, said detection cam(s) are not necessarily arranged on the side protuberances. In other words, the control device can be dissociated from the support means.

Advantageously then, the side openings are provided in conformations provided for blocking the work container against rotation. The conformations are arranged in a periodic manner to allow several positions for the work container. The appliance can however have blocking conformations not provided with side openings.

According to an advantageous arrangement, the conformations are concave. This arrangement facilitates the installation of the control element.

Advantageously the number of angular positions in which the work container can be placed on the motor housing is comprised between two and six. These arrangements allow use of the appliance by right-handed persons as well as by left-handed persons while preserving a simple realization for the safety device.

The invention will be better understood from a study of an example of realization, taken on a non-limiting basis, accompanied by alternatives, illustrated in the annexed figures, in which:

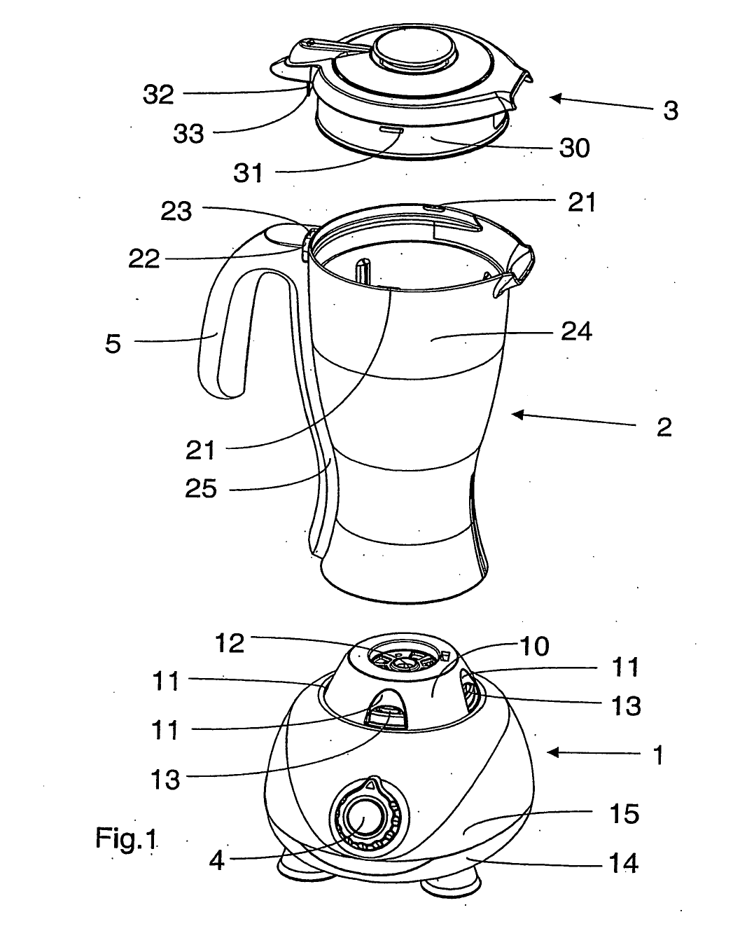

FIG. 1 is an exploded view of an electrical household food preparation appliance according to the invention,

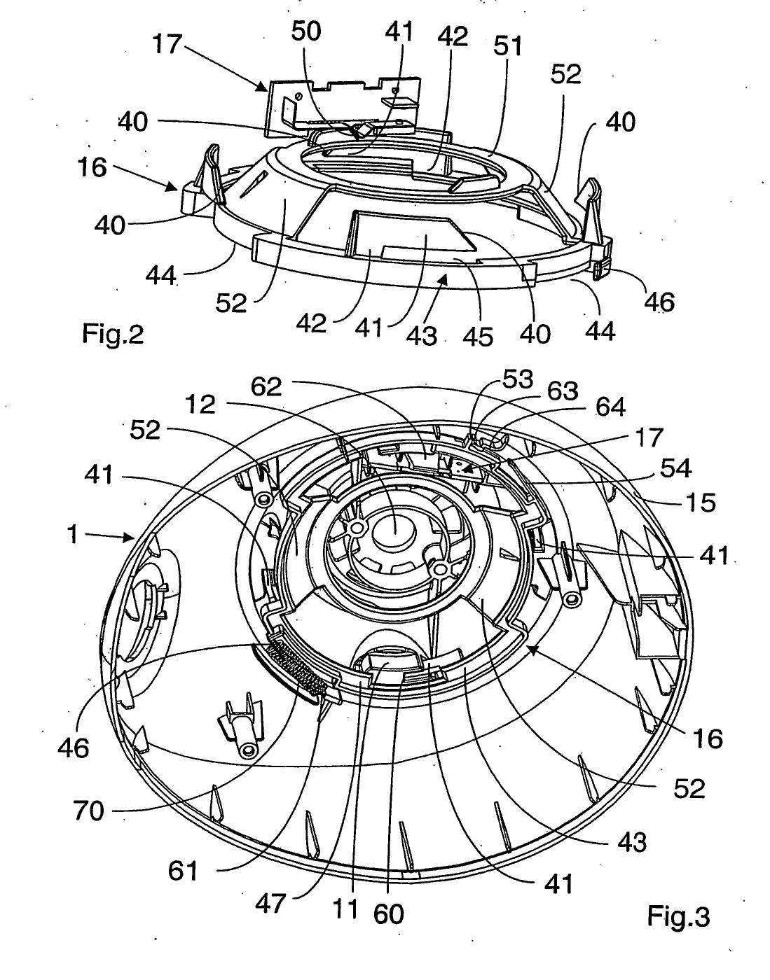

FIG. 2 is a perspective view of two elements of the safety device,

FIG. 3 is a bottom perspective view of the elements illustrated in FIG. 2 mounted in the upper part of the motor housing of the appliance,

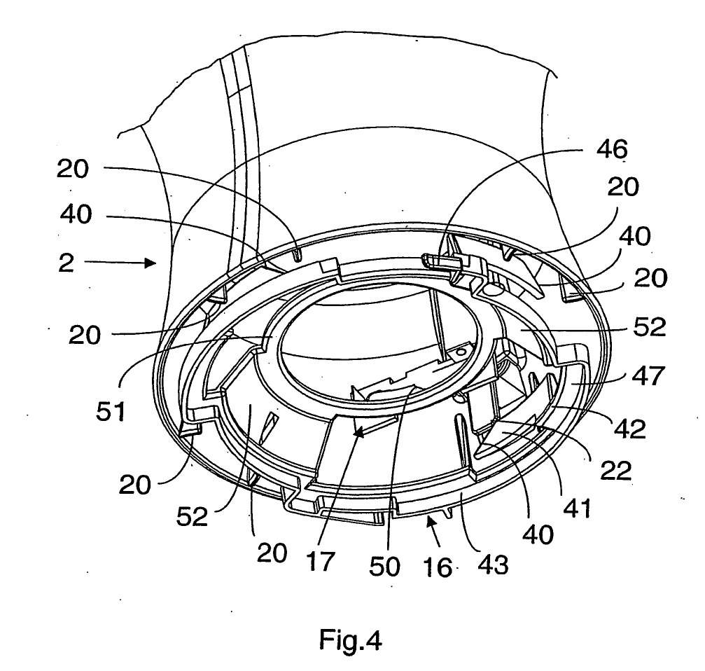

FIG. 4 is a bottom perspective view of the elements illustrated in FIG. 2 cooperating with the lower part of the work container of the appliance.

FIG. 1 shows an electrical household food preparation appliance according to the invention having a motor housing 1, a work container 2 provided to be placed on the motor housing 1 in several angular positions, and a lid 3 provided to close work container 2. Motor housing 1 has a control knob 4. Work container 2 has a handle 5.

Motor housing 1 forms a pedestal 10 for receiving work container 2. Pedestal 10 presents a series of conformations 11 arranged in a periodic manner. Conformations 11 are provided for blocking work container 2 against rotation.

More particularly, conformations 11 are four in number, and make it possible to offer to work container 2 four different positions on pedestal 10. In particular, work container 2 can be disposed on motor housing 1 with handle 5 to the left of control knob 4, as shown in FIG. 1, or to the right, two other positions also being possible. As an alternative, motor housing 1 has at least two conformations 11.

Motor housing 1 has a motor provided to actuate a working tool disposed in work container 2. For this purpose pedestal 10 presents an axial opening 12 provided for the passage of a drive shaft (not shown in the figures).

Lid 3 can be locked on work container 2 by a bayonet system. For this purpose lid 3 presents a skirt 30 having lugs 31 provided to cooperate with lugs 21 arranged on the internal wall of the upper edge of work container 2. Locking of lid 3 is carried out by rotation.

Lid 3 has a detection body 32 forming part of a safety device prohibiting operation of the motor of the appliance when work container 2 is in place on motor housing 1 and lid 3 is not locked on work container 2.

Detection body 32 is designed to cooperate with a transmission element 22 arranged in work container 2. For this purpose detection body 32 presents a control cam 33 provided to cooperate with the upper part of transmission element 22 located opposite a cut-out 23 provided in a wall of work container 2. More particularly transmission element 22 is mounted between a receptacle 24 and an attached wall 25. Handle 5 extending from attached wall 25.

Conformations 11 of pedestal 10 are concave and each one presents an upper opening 13 provided for the passage of the lower part of transmission element 22. Motor housing 1 has a base 14 surmounted by a body 15. Pedestal 10 is arranged on body 15.

The safety device also has a control element 16 and a safety switch 17, illustrated in FIG. 2. Control element 16 and safety switch 17 are arranged in motor housing 1. FIG. 3 illustrates control element 16 and safety switch 17 mounted in body 15 of motor housing 1.

Control element 16 forms a crown 43. Control element 16 has several detection cams 40 provided to cooperate with transmission element 22. Each detection cam 40 is provided at one end with a side protuberance 41 connected by an upright 42 to crown 43. Side protuberances 41 are arranged on a diameter and have a substantially constant wall thickness. Thus, side protuberances 41 are curved, such as visible in FIG. 2. Crown 43 presents internal recesses 44 and external recesses 45 under side protuberances 41 to facilitate the realization of control element 16 as a single molded part. Crown 43 presents a tenon 46 provided to receive a restoring means, visible in FIG. 3.

Control element 16 carries an actuation cam of 50 provided to actuate switch 17. Actuation cam 50 extends from an upper crown 51 connected to crown 43 by two walls 52. Upper crown 51 allows passage of the shaft of the motor (not represented in the figures).

Body 15 presents side openings 60 provided for the introduction of the ends of side protuberances 41 carrying detection cams 40. Side openings 60 are arranged in conformations 11 provided for blocking work container 2 against rotation. Control element 16 has internal radial wall portions 47 arranged inside crown 43. Internal radial wall portions 47 make it possible to rigidify crown 43. Internal radial wall portions 47 are interrupted under side protuberances 41.

Thus when side protuberances 41 are engaged in side openings 60 of body 15, control element 16 is suspended in body 15 by side protuberances 41.

A restoring means 70 is assembled between body 15 and control element 16. Control element 16 is mounted to be movable in rotation in opposition to restoring means 70. The stiffness of restoring means 70 and the slope of detection cams 40 are selected so that the weight of work container 2 and lid 3 is sufficient to push back restoring means 70 while leaving work container 2 resting against pedestal 10. More particularly, restoring means 70 is formed by a helical spring assembled between a tenon 61 of body 15 and tenon 46 of control element 16.

Body 15 has a hook 62 forming a means for retaining switch 17.

Control element 16 carries a lug 53 provided to cooperate with an abutment 63 of body 15 and an elastic strip 54 provided to cooperate with another abutment 64 of body 15. Abutments 63 and 64 limit the angular travel of control element 16. Lug 53 extends radially towards the outside starting from crown 43. Elastic strip 54 extends substantially transversely with respect to crown 43.

FIG. 4 represents one of the detection cams 40 actuated by the lower part of transmission element 22 when work container 2 is disposed on pedestal 10 (not represented in the figure). Transmission element 22 is for example formed by a rod mounted against a restoring spring, this rod being movable with respect to the work container in a substantially vertical direction. Control element 16 is movable against restoring means 70 in a direction forming an angle with the direction of displacement of the lower end of transmission element 22.

Work container 2 has conformations 20 provided to cooperate with conformations 11 of pedestal 10 in order to immobilize in rotation the work container 2 relative to pedestal 10. Work container 2 also has a working tool provided to be driven by the motor, not illustrated in the figures.

The mounting of control element 16 is carried out by positioning side protuberances 41 at the level of side openings 60. Elastic strip 54 is then disposed behind abutment 63. Crown 43 is then turned to introduce side protuberances 41 into side openings 60. The free end of elastic strip 54 passes behind abutment 63 and 64 during rotation of crown 43. Lug 53 then comes into contact with abutment 63. Side protuberances 41 are engaged in side openings 60. A rotation of crown 43 in the other direction brings the end of the elastic strip 54 into contact with abutment 64. The travel of control element 16 is thus limited. Restoring spring 70 mounted between tenons 46 and 61 brings lug 53 into contact with abutment 63, as represented in FIG. 4.

Thus control element 16 is mounted suspended with respect to motor housing 1. The assembly is particularly simple since it is sufficient to insert control element 16 in motor housing 1 and to install restoring means 70. Control element 16 is locked in place thanks to elastic strip 54.

Control element 16 is mounted suspended to body 15 by side protuberances 41 engaged in side openings 60. Only the lower edges of side protuberances 41 rest on body 15. The friction force between control element 16 and body 15 is thus particularly weak. Moreover, the arrangement of control cams 40 on the side protuberances 41 facilitate the transmission of the movement of transmission element 22 to control element 16.

The present invention functions in the following way.

The user places work container 2 on pedestal 10 in one of the four possible positions. Conformations 20 of work container 2 engage in conformations 11 of pedestal 10. The lower end of transmission element 22 then faces one of upper openings 13. However as long as lid 3 is not locked on work container 2 disposed on motor housing 1, transmission element 22 cannot actuate control element 16. When lid 3 is locked on work container 2, control cam 33 pushes transmission element 22 downwardly. The lower end of transmission element 22 engaged in one of the upper openings 13 then pushes back one of the detection cams 40 towards the side opening 60, rotating control element 16. Actuation cam 50 cooperates then with switch 17 to allow the operation of the appliance.

When the user withdraws work container 2 from pedestal 10 or unlocks lid 3, transmission element 22 releases detection cam 40, provoking rotation of control element 16 under the action of restoring means 70. Actuation cam 50 moves away from switch 17, leading to the interruption of power to the motor of the appliance.

Thanks to the four possible positions of work container 2 on motor housing 1, the user must turn work container 2 by at most 45° to be able to install said work container on housing 1. Such an arrangement is already known in appliances not provided with safety device detecting the presence of the lid.

The present invention makes it possible to offer this advantage with an appliance equipped with a safety device detecting the presence of the lid.

As an alternative, motor housing 1 and work receptacle 2 do not necessarily have four different installation positions. In a preferred manner the number of angular positions in which work container 2 can be placed on motor housing 1 is comprised between two and six.

As an alternative, work receptacle 2 and lid 3 can be replaced by any type of accessory having a body closed by a lid.

As an alternative, conformations 11 are not necessarily concave.

As an alternative, the upper openings 13 are not necessarily arranged in conformations 11.

As an alternative, transmission element 22 can be made in several parts. The lower end of transmission element 22 cooperating with control element 16 is not necessarily movable in a strictly vertical direction.

As an alternative, detection cams 40 are not necessarily arranged on side protuberances 41.

The present invention is by no means limited to the example of realization described and its alternatives, but includes many modifications within the framework of the claims.

1. Electrical household food preparation appliance, comprising a motor housing (1), a work container (2) provided to be placed on the motor housing (1), a lid (3) provided to close the work container (2), the lid (3) having a detection body (32) provided to cooperate with a transmission element (22) arranged in the work container (2) when the lid (3) is locked on the work container (2), the transmission element (22) cooperating with a control element (16) arranged in the motor housing (1) to allow operation of the appliance when the lid (3) closes the work container (2) disposed on the motor housing (1), wherein the work container (2) can be placed on the motor housing (1) in several angular positions and in that the control element (16) is mounted to be movable in rotation against a restoring means (70) and has several detection cams (40) arranged to cooperate with the transmission element (22).

2. Electrical household food preparation appliance according to claim 1, wherein the control element (16) forms a crown (43).

3. Electrical household food preparation appliance according to claim 1, wherein the control element (16) is mounted suspended to a body (15) of the motor housing (1) forming a pedestal (10) for reception of the work container (2).

4. Electrical household food preparation appliance according to claim 1, wherein the control element (16) has side protuberances (41) engaged in side openings (60) of the motor housing (1).

5. Electrical household food preparation appliance according to claim 4, wherein at least one of the side protuberances (41) carries one of the detection cams (40) provided to cooperate with the transmission element (22).

6. Electrical household food preparation appliance according to claim 4, wherein in that the side openings (60) are arranged in conformations (11) provided for blocking the work container (2) against rotation.

7. Electrical household food preparation appliance according to claim 6, wherein conformations (11) are concave.

8. Electrical household food preparation appliance according to claim 1, wherein the number of angular positions in which the work container (2) can be placed on the motor housing (1) is comprised between two and six.
